(19) United States
(12) Patent Application Publication
(10) Pub. No.: US 2026/0135356 A1
(43) Pub. Date: May 14, 2026

(54) STAMPED STRUCTURAL SPRING FOR THERMAL MANAGEMENT OF MICROGRID INTERCONNECTION DEVICES

(71) Applicant: EATON INTELLIGENT POWER LIMITED, DUBLIN 4 (IE)

(72) Inventors: Milind Pandya, Pune (IN); Ravi Shankar Panday, Lucknow (IN); Ravi Sidhpuria, Surat (IN); Mahesh Ighe, Pune (IN)

(73) Assignee: EATON INTELLIGENT POWER LIMITED, DUBLIN 4 (IE)

(21) Appl. No.: 18/947,461

(22) Filed: Nov. 14, 2024

(51) Int. Cl. H02B 1/56; H02B 1/015

(52) U.S. Cl. CPC H02B 1/56; H02B 1/015

(57) ABSTRACT

A thermally conductive structural spring is provided for installation in a microgrid interconnection device (MID) to counteract temperature increase in the MID as efficiently as possible. The spring is structured to provide a physical link from the terminals of a bus branch in the MID to the outer casing of the MID. The direct physical link between the terminals of the bus branch and the outer casing provides a path that conducts heat away from the terminals to the outer casing efficiently. In addition, the spring is proportioned to get compressed slightly when installed between the bus terminals and the outer casing. The compression of the spring decreases thermal resistance between the spring and the bus terminals and between the spring and the outer casing, thus further increasing the thermal conduction efficiency of the conduction path.

### FIELD OF THE INVENTION

The disclosed concept relates generally to microgrid interconnection devices (MIDs), and in particular, to thermal management devices and systems for MIDs.

### BACKGROUND OF THE INVENTION

DER (distributed energy resource) systems are relatively small-scale power sources that generate electricity on-site for individual electricity consumers and can be interconnected to the utility electrical grid. DERs enable a consumer to supplement and sometimes replace their use of utility power and can also sometimes supply/backfeed power to the utility grid. A microgrid interconnection device (MID) is a type of distribution panel used to monitor and manage a microgrid's connection and disconnection between a utility power source and DER systems. MIDs must comply with applicable safety standards such as UL 67, which is directed to service entrance safety requirements.

In order for an MID to receive UL listing, temperature within the MID cannot exceed 65° C. (117° F.) rise over ambient. It will be appreciated that providing efficient thermal management in an MID is a crucial aspect of preventing excessive temperature rise the MID. Under certain conditions in some existing MIDs, temperature rise consistently exceeds 65° C. over ambient, so more efficacious thermal management approaches are needed in these devices.

There is thus room for improvement in MIDs, and in thermal management devices and systems therefor.

### SUMMARY OF THE INVENTION

These needs, and others, are met by embodiments of a thermally conductive structural spring that is structured to be installed in an MID to provide a physical link from the terminals of a bus branch in the MID to the outer casing of the MID. The direct physical link between the terminals of the bus branch and the outer casing provides a path that conducts heat away from the terminals to the outer casing efficiently. In addition, the structural spring is proportioned such that it gets compressed slightly when installed between the bus terminals and the outer casing. The compression of the structural spring decreases thermal resistance between the spring and the bus terminals and between the spring and the outer casing, thus increasing the thermal conduction efficiency of the conduction path.

In one embodiment of the disclosed concept, a thermal management spring is provided for use with a microgrid interconnect device (MID). The MID comprises an outer casing that houses an electrical bus with a terminal branch, the terminal branch having a line terminal structured to be connected to a power source and a load terminal structured to be connected to a load, and the line terminal and load terminal being electrically connected to one another, with the line terminal and load terminal being spaced apart from the outer casing relative to a depth dimension. The thermal management spring comprises: a line end structured to be coupled to the line terminal; a load end structured to be coupled to the load terminal; a first stamped arm extending from the line end; a second stamped arm extending from the load end; and a wall engaging side that extends between the first stamped arm and the second stamped arm and connects the first stamped arm to the second stamped arm. The first stamped arm and second stamped arm are structured to compress in the depth dimension. The first stamped arm and second stamped arm are structured such that, in order to install the thermal management spring in the MID, a compressive force must be applied to the first stamped arm and second stamped arm in order to position the first stamped arm between the outer casing and the line terminal and in order to position the second stamped arm between the outer casing and the load terminal. The first stamped arm and the second stamped arm are structured to exert an expansion force upon the outer casing and the terminal branch when the compressive force is removed from the first stamped arm and from the second stamped arm after installation of the thermal management spring in the MID. The first stamped arm and the second stamped arm are structured such that the expansion force: couples the line end to the line terminal, couples the load end to the load terminal, and couples the wall engaging side to the outer casing.

In another embodiment of the disclosed concept, a microgrid interconnect device (MID) comprises an electrical bus, an outer casing that houses the electrical bus, and a thermal management spring. The electrical bus has a terminal branch that includes a line terminal structured to be connected to a power source and a load terminal structured to be connected to a load, with the line terminal and the load terminal being electrically connected to one another. The thermal management spring comprises: a line end structured to be coupled to the line terminal; a load end structured to be coupled to the load terminal; a first stamped arm extending from the line end; a second stamped arm extending from the load end; and a wall engaging side that extends between the first stamped arm and the second stamped arm and connects the first stamped arm to the second stamped arm. The line terminal and load terminal are spaced apart from the outer casing relative to a depth dimension. The first stamped arm and second stamped arm are structured to compress in the depth dimension. The first stamped arm and second stamped arm are structured such that, in order to install the thermal management spring in the MID, a compressive force must be applied to the first stamped arm and second stamped arm in order to position the first stamped arm between the outer casing and the line terminal and in order to position the second stamped arm between the outer casing and the load terminal. The first stamped arm and the second stamped arm are structured to exert an expansion force upon the outer casing and the terminal branch when the compressive force is removed from the first stamped arm and from the second stamped arm after installation of the thermal management spring in the MID. The first stamped arm and the second stamped arm are structured such that the expansion force: couples the line end to the line terminal, couples the load end to the load terminal, and couples the wall engaging side to the outer casing.

### BRIEF DESCRIPTION OF THE DRAWINGS

A full understanding of the invention can be gained from the following description of the preferred embodiments when read in conjunction with the accompanying drawings in which:

FIG. 1 is a perspective view of a stamped structural spring for providing thermal management in an MID, in accordance with an exemplary embodiment of the disclosed concept, the stamped structural spring being shown coupled to the bus bar of an MID;

FIG. 2 is a perspective view of the stamped structural spring and MID bus bar shown in FIG. 1, shown with the bus bar connected to an inner housing of the MID; and

FIG. 3 is a side elevational view of the stamped structural spring and MID components shown in FIG. 2, with an outer casing of the MID additionally shown, demonstrating how the stamped structural spring is structured to be coupled to the outer casing of the MID, in accordance with an exemplary embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “geometric distance” shall denote the shortest distance between two points.

As employed herein, the term “number” shall mean one or an integer greater than one (i.e., a plurality).

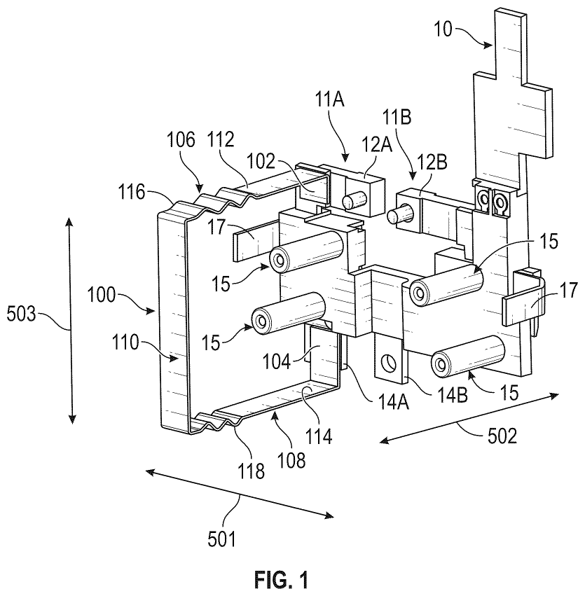

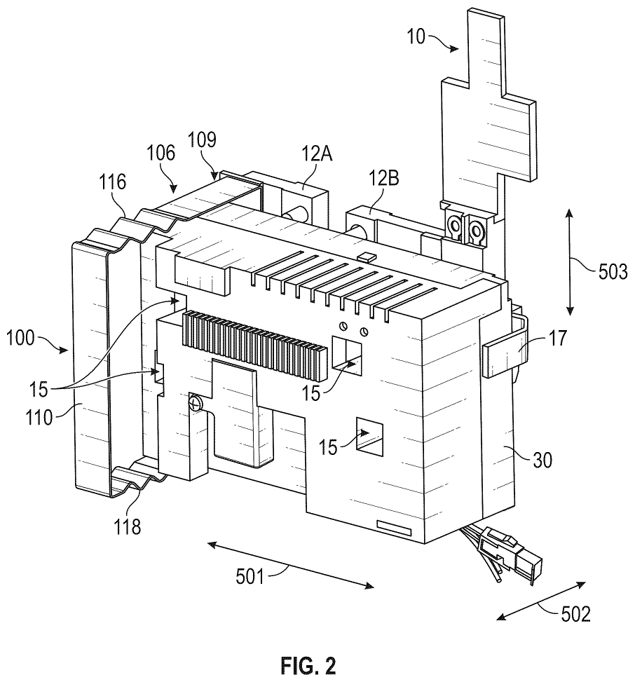

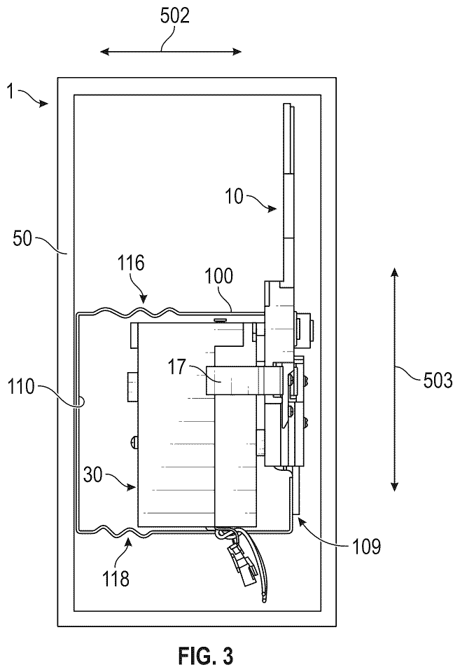

Described herein are embodiments of a structural spring 100 (referred to hereinafter as the “thermal management spring 100”) whose structure is advantageously designed to conduct heat away from electrical components in an existing MID 1 more quickly and efficiently than existing thermal management systems for MIDs do. FIGS. 1-3 show the thermal management spring 100, in accordance with an exemplary embodiment of the disclosed concept. In each of FIGS. 1-3, the thermal management spring 100 is shown coupled to an electrical bus 10 of the MID 1. In FIG. 1, only the bus 10 of the MID 1 is shown. In FIG. 2, an electrically insulative interior housing 30 of the MID 1 is shown coupled to the bus 10. In FIG. 3, an outer casing 50 of the MID 1 is depicted symbolically and shown enclosing the bus 10 and the interior housing 30. The MID 1 comprises some other components not shown in FIG. 3 that are not relevant to the disclosed thermal management solution, but FIG. 3 provides a representative depiction of the overall structure of the fully assembled MID 1 and of those components relevant to the thermal management of the MID 1. The outer casing 50 and interior housing 30 are hidden in varying combinations in FIGS. 1 and 2 in order to assist the viewer in understanding how the thermal management spring 100 gets coupled to the bus 10 in order to conduct heat away from the bus 10.

The bus 10 comprises a plurality of terminal branches 11, with each terminal branch 11 comprising one line terminal 12 and one load terminal 14. In FIG. 1, the electrical terminal branches are numbered as 11A and 11B to enable each individual terminal branch 11 to be identified with specificity as needed, but the electrical terminal branches can also be referred to generally and individually or generally and collectively with the reference number 11. Any other components that are numbered with reference numbers having letters appended (e.g. the line terminals 12A and 12B or the load terminals 14A and 14B) should be similarly understood to be able to be referred to generally and individually or generally and collectively with only the reference number not having the letter appended (e.g. the “line terminals 12” and the “load terminals 14”).

Each line terminal 12 is structured to be connected to a power source (not shown), such as, for example and without limitation, a DER. Each load terminal 14 is structured to be connected to a load (not shown), with each load terminal 14 corresponding to and being electrically connected to one line terminal 12. The line terminal 12A and load terminal 14A are electrically connected to each other, and the line terminal 12B and load terminal 14B are electrically connected to each other. Each terminal branch 11 also comprises a number of electrical terminal posts 15 that provide access to the terminal branch 11 when the interior housing 30 is coupled to the electrical bus 10, as shown in FIG. 2.

The existing approach for thermal management in the MID 1 utilizes two metal tabs 17 connected to the electrical bus 10. As can be seen in FIG. 2, the tabs 17 and interior housing 30 are structured such that the tabs 17 engage the side wall of the interior housing 30. The engagement between the tabs 17 and the side walls of the interior housing 30 facilitates the transfer of some heat from the electrical bus 10 to the interior housing 30, but not enough to enable the MID 1 to consistently meet the standards set by UL 67. The disclosed thermal management spring 100 differs from the existing approach in that the thermal management spring 100 physically couples the line terminal 12 and the load terminal 14 to the outer casing 50 and in that the thermal management spring 100 exerts compressive force on the line terminal 12 and on the load terminal 14 that increases the heat dissipated from the electrical bus 10, as detailed hereinafter. The disclosed thermal management spring 100 is structured to be coupled to one terminal branch 11 at a time. In the figures, only one thermal management spring 100 is shown, said thermal management spring 100 being coupled to the terminal branch 11A, but a separate additional thermal management spring 100 could be connected to the terminal branch 11B, if desired.

The thermal management spring 100 is produced from thermally conductive material and comprises a line end 102, a load end 104, a first stamped arm 106 extending from the line end 102, a second stamped arm 108 extending from the load end 104, and a wall engaging side 110 that connects the first stamped arm 106 and the second stamped arm 108 by extending between the two stamped arms 106, 108. The stamped arms 106 and 108 are referred to using the terms “first” and “second” solely to differentiate one from the other, such that the stamped arm 106 can instead be referred to as “second” and the stamped arm 108 can instead be referred to as “first”. The line end 102 is structured to be coupled to the line terminal 12 of a given terminal branch 11 using thermal paste 109 (indicated in FIG. 2) and the load end 104 is structured to be coupled to the load terminal 14 of the given terminal branch 11 using thermal paste 109 (indicated in FIG. 3). The compressive force exerted by the spring 100 (detailed further later herein) also couples the spring 100 to the line terminal 12 and to the load terminal 14. The stamped arms 106, 108 are proportioned to be long enough to extend from the respective line end 102 or load end 104 to a wall of the outer casing 50. The stamped arms 106, 108 are also orthogonal to the respective line end 102 and load end 104. The wall engaging side 110 is structured such that the entire length of the wall engaging side 110 engages a wall of the outer casing 50 and is coupled to the outer casing 50, as shown in FIG. 3. It is noted that the thermal management spring 100 can be proportioned so that the wall engaging side 110 engages some surface in the interior of the MID 1 instead of the outer casing 50, but the remaining discussion of the wall engaging side 110 provided herein will refer to the wall engaging side 110 as engaging the outer casing 50. The thermal management spring 100 is structured to surround the interior housing 30, as shown in FIGS. 2 and 3.

In order to provide a common frame of reference between the figures, three dimensions are labeled in FIGS. 1-3. The labeled dimensions include a width dimension 501, a depth dimension 502, and a height dimension 503. Each of the three dimensions is orthogonal to the other two dimensions. The use of the terms “width”, “depth”, and “height” to refer to the dimensions 501, 502, and 503 is intended solely to facilitate ease of explanation and should not be construed as limiting the orientations in which the devices shown in the figures can be used.

It is noted that the depth dimension 502 is the dimension in which the distance between the line terminal 12 and outer casing 50 and the distance between the load terminal 14 and outer casing 50 is measured. Each stamped arm 106, 108 respectively comprises a planar portion 112, 114 and a stamped portion 116, 118 formed by mechanical stamping. The planar portions 112, 114 are flat relative to a plane orthogonal to the height dimension 503 (i.e. the plane extending in the width and depth dimensions 501, 502). In contrast, each stamped portion 116, 118 is non-planar and oscillates in the height dimension 503 (as can be seen most clearly in FIG. 3). The stamped portions 116, 118 enable the stamped arms 106, 108 to compress slightly from their unloaded state, thus enabling the thermal management spring 100 to function as a spring between the outer casing 50 and the line and load terminals 12, 14. This compression is in the depth dimension 502 when the thermal management spring 100 is installed in the MID 1.

When installing the thermal management spring 100 in the MID 1, after the thermal paste 109 is applied between the line end 102 and the line terminal 12 and between the load end 104 and the load terminal 14, the spring 100 gets compressed in the depth dimension 502 so that the stamped arm 106 can be aligned between the line terminal 12 and the outer casing 50 and so that the stamped arm 108 can be aligned between the load terminal 14 and the outer casing 50. When the compressive force is removed from the spring 100, the expansion force exerted by the spring 100 in the depth dimension 502 ensures a tight fit of the spring 100 between the outer casing 50 and the terminal branch 11 such that the spring 100 remains in position within the MID 1 without requiring the aid of any external mechanical fasteners (e.g. screws, bolts, etc.). In a non-limiting exemplary embodiment, the thermal management spring 100 is structured to compress a distance of 1 to 3 millimeters from its unloaded state.

The planar portion 112, 114 of each stamped arm 106, 108 is rigid and facilitates a tight fit of the thermal management spring 100 between the outer casing 50 and the terminal branch 11, while the compression provided by the stamped portion 116, 118 increases contact pressure between the wall engaging side 110 and the wall of the outer casing 50. This increased pressure increases surface area contact at two sets of sites: (1) between the outer casing 50 and the thermal management spring 100, and (2) between the thermal management spring 100 and the line and load terminals 12, 14. Increasing the surface area contact at these two sets of sites decreases thermal resistance at these sites, and thus increases thermal conductivity of the thermal management spring 100 between the bus 10 and the outer casing 50. In one non-limiting exemplary embodiment of the disclosed concept, the thermal management spring 100 is produced from aluminum, as aluminum has relatively high thermal conductivity and can be stamped relatively easily. However, the thermal management spring 100 can be produced from other materials without departing from the scope of the disclosed concept.

The structure of the MID 1 shown in the figures, and particularly the spatial relationship between the line terminal 12A and the load terminal 14A and the spatial relationship between each of the terminals 12A, 14A and the wall of the outer casing 50, leads to the specific iteration of the thermal management spring 100 shown in the figures being substantially rectangular in shape. Specifically, the rectangular structure of the specific thermal management spring 100 shown in the figures results from the line terminal 12A and the load terminal 14A overlapping in the width dimension 501 and being disposed the same geometric distance away from the outer casing 50 in the depth dimension 502, because this causes the two stamped arms 106, 108 to have the same length in the depth dimension 502 and to be parallel to one another, and also causes the wall engaging side 110 extending between the two stamped arms 106, 108 to be disposed orthogonally to both stamped arms 106, 108. However, it is noted that the exact structural shape of the thermal management spring 100 can vary between specific iterations, as the requirements of the thermal management spring 100 are: (1) that each arm 106, 108 be stamped so that the thermal management spring 100 can compress, (2) that each stamped arm 106, 108 be disposed perpendicularly to the wall engaging side 110 and perpendicularly to the line and load terminals 12, 14, and (3) that the wall engaging side 110 extend between the two stamped arms 106, 108 and engage the outer casing 50 (i.e. the interior wall of the outer casing 50).

For example and without limitation, a specific iteration of the thermal management spring 100 produced for use with the terminal branch 11B would not have the same structure as the specific iteration of the thermal management spring 100 that is shown in the figures and used with the terminal branch 11A, due to the line terminal 12B and the load terminal 14B not overlapping in the width dimension 501 (in contrast with the line terminal 12A and the load terminal 14A). This lack of overlap between the line terminal 12B and the load terminal 14B in the width dimension 501 results in the line terminal 12B not being positioned directly above the load terminal 14B relative to the height dimension 502. As such, a thermal management spring 100 structured for use with the terminal branch 11B would be longer in the width dimension 501 than the thermal management spring 100 shown in the figures, since the stamped arms 106, 108 that would extend from the line terminal 12B and the load terminal 14A toward the outer casing 50 would be displaced from one another relative to the width dimension 501. It will be appreciated that the wall engaging side 110 used with the terminal branch 11B could simply be extended further in the width dimension 501 than the wall engaging side 110 that is shown in the figures and used with the terminal branch 11A.

The disclosed thermal management spring 100 is advantageous in several respects. The primary advantage is that installing the thermal management spring 100 in the MID 1 enables the MID 1 to meet the UL 67 standards pertaining to temperature increase, whereas the existing solution of providing conductive heat transfer paths between the electrical terminal pairs 11 and the interior housing 30 via the metal tabs 17 does not always meet the UL 67 standards. In addition, the manufacturing (including stamping) and assembly of the thermal management spring 100 is easy and low-cost. Lastly, the thermal management spring 100 can be easily installed in existing MIDs to make them compliant with UL 67, rather than requiring that major changes be made the designs of existing MIDs.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A thermal management spring for use with a microgrid interconnect device, MID, the MID comprising an outer casing that houses an electrical bus with a terminal branch, the terminal branch including a line terminal structured to be connected to a power source and a load terminal structured to be connected to a load, the line terminal and the load terminal being electrically connected to one another, the line terminal and load terminal being spaced apart from the outer casing relative to a depth dimension, the thermal management spring comprising:
a line end structured to be coupled to the line terminal;
a load end structured to be coupled to the load terminal;
a first stamped arm extending from the line end;
a second stamped arm extending from the load end; and
a wall engaging side that extends between the first stamped arm and the second stamped arm and connects the first stamped arm to the second stamped arm,
wherein the first stamped arm and second stamped arm are structured to compress in the depth dimension,
wherein the first stamped arm and second stamped arm are structured such that, in order to install the thermal management spring in the MID, a compressive force must be applied to the first stamped arm and second stamped arm in order to position the first stamped arm between the outer casing and the line terminal and in order to position the second stamped arm between the outer casing and the load terminal,
wherein the first stamped arm and the second stamped arm are structured to exert an expansion force upon the outer casing and the terminal branch when the compressive force is removed from the first stamped arm and from the second stamped arm after installation of the thermal management spring in the MID, and
wherein the first stamped arm and the second stamped arm are structured such that the expansion force:
couples the line end to the line terminal,
couples the load end to the load terminal, and
couples the wall engaging side to the outer casing.

2. The thermal management spring of claim 1,
wherein the wall engaging side extends between the first stamped arm and the second stamped arm in a height dimension orthogonal to the depth dimension.

3. The thermal management spring of claim 2,
wherein the first stamped arm comprises a first planar portion and a first stamped portion,
wherein the second stamped arm comprises a second planar portion and a second stamped portion,
wherein the first planar portion and the second planar portion are flat in a plane orthogonal to the height dimension,
wherein the first stamped portion and the second stamped portion are non-planar and oscillate in the height dimension.

4. The thermal management spring of claim 1,
wherein the wall engaging side is orthogonal to the first stamped arm and the second stamped arm.

5. The thermal management spring of claim 1,
wherein the first stamped arm is orthogonal to the line end, and
wherein the second stamped arm is orthogonal to the load end.

6. The thermal management spring of claim 4,
wherein the first stamped arm is orthogonal to the line end, and
wherein the second stamped arm is orthogonal to the load end.

7. The thermal management spring of claim 1,
wherein the thermal management spring is produced from aluminum.

8. A microgrid interconnect device, MID, the MID comprising:
an electrical bus with a terminal branch, the terminal branch including a line terminal structured to be connected to a power source and a load terminal structured to be connected to a load, the line terminal and the load terminal being electrically connected to one another;
an outer casing that houses the electrical bus; and
a thermal management spring, the thermal management spring comprising:
a line end structured to be coupled to the line terminal;
a load end structured to be coupled to the load terminal;
a first stamped arm extending from the line end;
a second stamped arm extending from the load end; and
a wall engaging side that extends between the first stamped arm and the second stamped arm and connects the first stamped arm to the second stamped arm,
wherein the line terminal and the load terminal are spaced apart from the outer casing relative to a depth dimension,
wherein the first stamped arm and second stamped arm are structured to compress in the depth dimension,
wherein the first stamped arm and second stamped arm are structured such that, in order to install the thermal management spring in the MID, a compressive force must be applied to the first stamped arm and second stamped arm in order to position the first stamped arm between the outer casing and the line terminal and in order to position the second stamped arm between the outer casing and the load terminal,
wherein the first stamped arm and the second stamped arm are structured to exert an expansion force upon the outer casing and the terminal branch when the compressive force is removed from the first stamped arm and from the second stamped arm after installation of the thermal management spring in the MID, and
wherein the first stamped arm and the second stamped arm are structured such that the expansion force:
couples the line end to the line terminal,
couples the load end to the load terminal, and
couples the wall engaging side to the outer casing.

9. The MID of claim 8,
wherein the wall engaging side extends between the first stamped arm and the second stamped arm in a height dimension orthogonal to the depth dimension.

10. The MID of claim 9,
wherein the first stamped arm comprises a first planar portion and a first stamped portion,
wherein the second stamped arm comprises a second planar portion and a second stamped portion,
wherein the first planar portion and the second planar portion are flat in a plane orthogonal to the height dimension,
wherein the first stamped portion and the second stamped portion are non-planar and oscillate in the height dimension.

11. The MID of claim 1,
wherein the wall engaging side is orthogonal to the first stamped arm and the second stamped arm.

12. The MID of claim 1,
wherein the first stamped arm is orthogonal to the line end, and
wherein the second stamped arm is orthogonal to the load end.

13. The MID of claim 11,
wherein the first stamped arm is orthogonal to the line end, and
wherein the second stamped arm is orthogonal to the load end.

14. The MID of claim 8,
wherein the thermal management spring is produced from aluminum.

15. The MID of claim 8, further comprising:
thermal paste applied between the line end and the line terminal,
thermal paste applied between the load end and the load terminal.
